(19) United States
(12) Patent Application Publication
(10) Pub. No.: US 2012/0329697 A1
(43) Pub. Date: Dec. 27, 2012

(54) STABLE POLYMER CONTAINING TWO PHASE SYSTEMS

(76) Inventor: Travis Kyle HODGDON, Cincinnati, OH (US)

(21) Appl. No.: 13/534,501

(22) Filed: Jun. 27, 2012

Related U.S. Application Data
(60) Provisional application No. 61/501,426, filed on Jun. 27, 2011.

(51) Int. Cl. C11D 3/37; G06F 17/10

(52) U.S. Cl. 510/276; 703/2

(57) ABSTRACT

The present invention relates to processes for producing stable polymer containing two phase systems, polymers for use in two phase systems as well as products comprising such systems and methods of making and using same. Such polymer containing two phase systems offer enhanced rheology and active delivery benefits without the stability negatives that are associated with the addition of polymers to two phase systems.

### CROSS-REFERENCE TO RELATED APPLICATION

This application claims priority under 35 U.S.C. §119(e) to U.S. Provisional Application Ser. No. 61/501,426, filed Jun. 27, 2011.

### FIELD OF THE INVENTION

The present invention relates to processes for designing stable polymer containing two phase systems, polymers for use in two phase systems as well as products comprising such systems and methods of making and using same.

### BACKGROUND OF THE INVENTION

Two phase systems typically comprise a solvent phase and a second particulate phase that is dispersed as discrete particulates in such solvent phase. Such particulates may be vesicles or coacervates. In one aspect, two phase system may be a consumer product, for example a fabric enhancer. Such, consumer products may comprise other actives, for example, softener actives that are found in the consumer product but outside the aforementioned particulates. Regardless of where such actives are found, it is desirable to increase the deposition efficiency of such actives and/or tune the rheology as this can improve the performance of the two phase system and/or reduce the cost of such two phase systems. The deposition efficiency and/or rheology of systems is typically increased and/or tuned by the addition of polymers. Unfortunately, as a two phase system's polymer level is increased the two phase system's stability decreases. Eventually, as the level of polymer is increased, the two phase system's particulates will bulk separate, which manifests itself as phase separation, or a change in the two phase system's viscosity may occur, which may result in one of the two phase system's phases gelling.

Applicants recognized that the phase separation is driven by depletion induced flocculation due to excess polymer in the solvent phase of the fabric enhancer. Applicants discovered that the judicious selection of the type and level of the polymer(s) can lead to two phase systems that exhibit improved active deposition and/or rheology without exhibiting significantly increased stability negatives. While not being bound by theory, Applicants believe that such polymers should, on a plot of polymer concentration in the solvent of choice (X) versus polymer solvent solution viscosity (Y), exhibit an exponential increase in solvent viscosity, somewhere over at least 0.1% of the range of X equals 0.001 weight % to 25 weight % polymer, such that Y=bX^{a} where the exponent “a” is greater than or equal to 4, and b is the extrapolated solvent polymer solution viscosity when X is extrapolated to unity and the exponent “a” is, over the range of the fit, greater than or equal to 4.

The rheology of a two phase system is particularly enhanced when the polymer solvent solution fit for the equation Y=bX^{a} results in the exponent “a” being greater than or equal to 4 at a low X value. Thus, provided the polymer is properly selected, the formulator can use increased levels of such polymer and thus achieve the desired active deposition and/or rheology without the aforementioned stability negatives. In one aspect, the polymer and particulates that constitute the second phase having radii of hydration in the first phase that are equal, no greater than an order or magnitude different or even no greater than two orders or magnitude different can provide additional stability. Thus, Applicants provides improved two phase systems and processes of making and using same.

### SUMMARY OF THE INVENTION

The present invention relates to processes for designing stable polymer containing two phase systems, polymers for use in two phase systems as well as products comprising such systems and methods of making and using same.

### DETAILED DESCRIPTION OF THE INVENTION

### Definitions

As used herein “consumer products” includes, unless otherwise indicated, articles, baby care, beauty care, fabric & home care, family care, feminine care, health care, snack and/or beverage products or devices intended to be used or consumed in the form in which it is sold, and is not intended for subsequent commercial manufacture or modification. Such products include but are not limited to fabric softener, fabric enhancer, laundry additive, conditioners, hair colorants, body wash, shampoo, liquid dish detergent, and heavy duty laundry detergent products for and/or methods relating to treating hair (human, dog, and/or cat), including bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to oral care including toothpastes, tooth gels, tooth rinses, denture adhesives, tooth whitening; over-the-counter health care including cough and cold remedies, pain relievers, pet health and nutrition, and water purification; processed food products including salad dressings, sports drinks, and dairy substitutes.

As used herein, the term “cleaning and/or treatment composition” includes, unless otherwise indicated, cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various, liquid and rinse-aid types for household and institutional use; liquid cleaning and disinfecting agents, including antibacterial hand-wash types, cleaning bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, a ‘vesicle’ is a spherical particle comprised of a solvent core surrounded by one or more membranes each independently comprising a surfactant, lipid or mixture thereof. In the event that there are multiple membranes each membrane is typically separated by a thin layer of solvent.

As used herein, a ‘coacervate’ is a dense liquid phase containing a macromolecular solution of poor solvent affinity. These macromolecule-rich fluids typically result from complexing a polyelectrolyte with an oppositely charged polyelectrolyte, surfactant, lipid or colloidal particles.

As used herein, the term “situs” includes paper products, fabrics, garments and hard surfaces.

As used herein, the article such as “a”, “an”, and “the” when used in a claim, are understood to mean one or more of what is claimed or described.

As used herein, “unity” means the integer one in the concentration scale regardless of the units (i.e. ppm, weight percent etc.).

As used herein, charge may be expressed in millivolts.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Consumer Products and Process of Making

As taught by the present specification, including the examples included herein, the processes disclosed herein may be used to design consumer products and select components for use in consumer products.

In one aspect, a process of making a consumer product, said process comprising:
a) adding a polymer to a two phase system, said two phase system comprising a solvent phase and an active dispersed in said solvent phase as discrete particles; or
b) adding a polymer to a solvent and combining said solvent polymer combination and forming a two phase system by dispersing an active to form discrete active particles in said solvent polymer combination,
wherein said polymer has a substantially equal or neutral charge in relation to said discrete particles and for the equation below,

Y=bX^{a}
wherein:
X is the polymer concentration in the solvent polymer solution
Y is the polymer solvent solution viscosity at a shear rate of 0.01 l/s,
b is the extrapolated solvent polymer solution viscosity when X is extrapolated to unity and the exponent a is, over the range of the fit, greater than or equal to 4,
the polymer is selected such that the exponent a is greater than or equal to 4, from about 4 to about 50, from about 4.5 to about 50, from about 4.5 to about 20, from about 5 to about 20, from about 5 to about 10, from about 5 to about 7;
over at least 0.1%, at least 0.2%, from 0.2% to about 1%, or even from 0.2% to about 0.5% of the range of X equals 0.001 weight % to 25 weight % polymer, is disclosed.

In another aspect, a process of making a consumer product, said process comprising:

using an equation comprising the variables Y, X, b, and a, said variables being arranged in the order of the equation below, to select a polymer:

Y=bX^{a}
wherein:
X is the polymer concentration in the solvent polymer solution
Y is the polymer solvent solution viscosity at a shear rate of 0.01 l/s,
b is the extrapolated solvent polymer solution viscosity when X is extrapolated to unity and the exponent a is, over the range of the fit, greater than or equal to 4,
said polymer being selected such that the exponent a is greater than or equal to 4, from about 4 to about 50, from about 4.5 to about 50, from about 4.5 to about 20, from about 5 to about 20, from about 5 to about 10, from about 5 to about 7;
over at least 0.1%, at least 0.2%, from 0.2% to about 1%, or even from 0.2% to about 0.5% of the range of X equals 0.001 weight % to 25 weight % polymer; and
   a) adding said polymer to a two phase system, said two phase system comprising a solvent phase and an active dispersed in said solvent phase as discrete particles; or
   b) adding a polymer to a solvent and combining said solvent polymer combination and forming a two phase system by dispersing an active to form discrete active particles in said solvent polymer combination,
      said polymer having a substantially equal or neutral charge in relation to said discrete particles' is disclosed.

In another aspect, a process of making a consumer product, said process comprising:
a) adding a polymer to a two phase system, said two phase system comprising a solvent phase and an active dispersed in said solvent phase as discrete particles; or
b) adding a polymer to a solvent and combining said solvent polymer combination and forming a two phase system by dispersing an active to form discrete active particles in said solvent polymer combination,
   wherein said polymer has a substantially equal or neutral charge in relation to said discrete particles and for the equation below,

Y=bX^{a}
wherein:
X is the polymer concentration in said two phase system,
Y is the viscosity of said two phase system at a shear rate of 0.01 l/s,
b is the extrapolated two phase system viscosity when X is extrapolated to unity and the exponent a is, over the range of the fit, greater than or equal to 4,
the polymer is selected such that the exponent a is greater than or equal to 4, from about 4 to about 50, from about 4.5 to about 50, from about 4.5 to about 20, from about 5 to about 20, from about 5 to about 10, from about 5 to about 7;
over at least 0.1%, at least 0.2%, from 0.2% to about 1%, or even from 0.2% to about 0.5% of the range of X equals 0.001 weight % to 25 weight % polymer is disclosed.

In another aspect, a process of making a consumer product, said process comprising:
a) adding said selected polymer to a two phase system, said two phase system comprising a solvent phase and an active dispersed in said solvent phase as discrete particles; or
b) adding said selected polymer to a solvent and combining said solvent polymer combination and forming a two phase system by dispersing an active to form discrete active particles in said solvent polymer combination,
   said polymer having a substantially equal or neutral charge in relation to said discrete particles wherein said polymer is selected by using an equation comprising the variables Y, X, b, and a, said variables being arranged in the order of the equation below:

Y=bX^{a}
wherein:
   X is the polymer concentration in said two phase system,
   Y is the two phase system viscosity at a shear rate of 0.01 l/s,
   b is the extrapolated two phase system viscosity when X is extrapolated to unity and the exponent a is, over the range of the fit, greater than or equal to 4,
said polymer being selected such that the exponent a is greater than or equal to 4, from about 4 to about 50, from about 4.5 to about 50, from about 4.5 to about 20, from about 5 to about 20, from about 5 to about 10, from about 5 to about 7; over at least 0.1%, at least 0.2%, from 0.2% to about 1%, or even from 0.2% to about 0.5% of the range of X equals 0.001 weight % to 25 weight % polymer
   is disclosed.

In one aspect of the aforementioned processes, a computer is used to perform the calculations relating to the aforementioned step of using the equation Y=bX^{a}.

In one aspect, such computer may be a portable computer such as personal computer.

A two phase systems, including two phase systems that are consumer products made according to any of the aforementioned processes are also disclosed.

### Suitable Material for Two Phase Systems

Solvent—Any suitable solvent system may be used in the present invention. In one aspect, the solvent phase is polar when the dispersed phase is non-polar. In another aspect, the solvent is non-polar when the disperse phase is polar or the solvent is polar or non-polar when the dispersed phase is solid.
Non-Polar Solvents—Non-Polar solvents employed in the present invention include, but are not limited to, any suitable aliphatic or aromatic solvents or mixtures thereof provided such mixtures result in a single continuous phase. Examples of suitable non-polar solvents include, but are not limited to, pentane, hexane, heptane, cyclohexane, benzene, toluene, xylene, diethyl ether, halogenated solvents such as carbon tetrachloride, silicones, and mixtures thereof.
Polar Solvents—Polar solvents may include any suitable polar solvent, including, but not limited to, water, methanol, ethanol, isopropanol, n-propanol, n-butanol, glycerol, diethyl ether, tetrahydrofuran, formic acid, acetic acid, acetone, and mixtures thereof. In the area of certain consumer products, for example fabric enhancers, suitable solvents include but are not limited to water.

### Actives for Dispersion

Solid polymeric particles—Solid polymeric particles, in one aspect smaller than 10 microns, like latex and polyethylene may be dispersed in the solvent phase. Latex may be natural rubber or synthetic. Commonly available synthetic latexes include nitrile rubber, polychloroprene, butyl rubber, fluorocarbon rubber, polyurethane, styrene-butadiene rubber and blends thereof. Polyethylene particles are available under the tradename VELUSTROL from HOECHST Aktiengesellschaft of Frankfurt am Main, Germany.
Fats, oils and waxes—The dispersed phase can comprise of fats, oils and waxes. Non-limiting examples of fats include vegetable oils, tallow, lard, marine oils, synthetic oils and mixtures thereof. The fats may be fractionated, partially or fully hydrogenated, and/or interesterified. Vegetable sources for oils may include coconut, corn, cottonseed, grape seed, peanut, olive, palm, rapeseed, sesame, soybean and sunflower. Examples of fats are milk, butter, Vaseline, paraffin, lanolin and silicon oils. Waxes that may be used are sipol wax, lanolin wax, beeswax, candelilla wax, microcrystalline wax, and silicone wax.
Perfumes—The dispersed phase may be comprise a perfume may include materials selected from the group consisting of perfumes such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, α-damascone, β-damascone, δ-damascone, β-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and β-dihydro ionone, linalool, ethyllinalool, tetrahydrolinalool, and dihydromyrcenol.
Encapsulates—The dispersed phase may be comprise encapsulates. Suitable encapsulates include perfume microcapsules comprising a shell that encapsulates a core. Said core comprising one or more benefits agent. Said benefit agent may include materials selected from the group consisting of perfumes such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, α-damascone, β-damascone, δ-damascone, β-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and β-dihydro ionone, linalool, ethyllinalool, tetrahydrolinalool, and dihydromyrcenol; silicone oils, waxes such as polyethylene waxes; hydrocarbons such as petrolatum; essential oils such as fish oils, jasmine, camphor, lavender; skin coolants such as menthol, methyl lactate; vitamins such as Vitamin A and E; sunscreens; glycerine; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, N.J., USA, International Flavors & Fragrances Corp. of South Brunswick, N.J., USA, or Quest Corp. of Naarden, Netherlands. Said shell may comprise materials selected from the group consisting of reaction products of one or more amines with one or more aldehydes, such as urea cross-linked with formaldehyde or gluteraldehyde, melamine cross-linked with formaldehyde; gelatin-polyphosphate coacervates optionally cross-linked with gluteraldehyde; gelatin-gum Arabic coacervates; cross-linked silicone fluids; polyamine reacted with polyisocyanates, acrylates and mixtures thereof.

In one aspect, said encapsulate may comprise a coating that encapsulates said shell. Said coating providing additional benefits that may include enhancing the deposition characteristics of the encapsulate and/or the encapsulate's benefit agent. In one aspect, said coating may comprise one or more efficiency polymers selected from the group consisting of polyvinyl amines, polyvinyl formamides, and polyallyl amines and copolymers thereof. In one aspect, said encapsulate may be a perfume microcapsule that has a shell comprising melamine formaldehyde and/or an acrylate and a core that comprises perfume. Said perfume microcapsule may comprise an optional coating listed above.

### Fabric Softening Active Compounds

A first type of fabric softening active comprises, as the principal active, compounds of the formula

{R₍₄₋ₘ₎—N⁺—[(CH₂)ₙ—Y—R¹]ₘ}X⁻ (1)

wherein each R substituent is either hydrogen, a short chain C₁-C₆, in one aspect C₁-C₃ alkyl or hydroxyalkyl group, e.g., methyl, ethyl, propyl, hydroxyethyl, and the like, poly (C₂₋₃ alkoxy), in one aspect polyethoxy, benzyl, or mixtures thereof; each m is 2 or 3; each n is from 1 to about 4, in one aspect 2; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, in one aspect C₁₄-C₂₀, with each R¹ being a hydrocarbyl, or substituted hydrocarbyl group, and X⁻ can be any softener-compatible anion, in one aspect, chloride, bromide, methylsulfate, ethylsulfate, sulfate, and nitrate, in one aspect chloride or methyl sulfate;

A second type of fabric softening active has the general formula:

[R₃N⁺CH₂CH(YR¹)(CH₂YR¹)]X⁻

wherein each Y, R, R¹, and X⁻ have the same meanings as before. Such compounds include those having the formula:

[CH₃]₃N⁽⁺⁾[CH₂CH(CH₂O(O)CR¹)O(O)CR¹]Cl⁽⁻⁾ (2)

wherein each R is a methyl or ethyl group and in one aspect each R¹ is in the range of C₁₅ to C₁₉. As used herein, when the diester is specified, it can include the monoester that is present.

These types of agents and general methods of making them are disclosed in U.S. Pat. No. 4,137,180, Naik et al., issued Jan. 30, 1979, which is incorporated herein by reference. An example of a suitable DEQA (2) is the “propyl” ester quaternary ammonium fabric softener active having the formula 1,2-di(acyloxy)-3-trimethylammoniopropane chloride.

A third type of suitable fabric softening active has the formula:

[R₄₋ₘ—N⁺—R¹ₘ]X⁻ (3)

wherein each R, R¹, and X⁻ have the same meanings as before.

A fourth type of suitable fabric softening active has the formula:

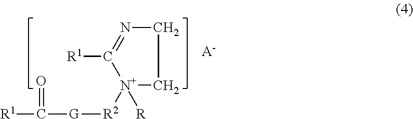

wherein each R, R¹, and A⁻ have the definitions given above; each R² is a C₁₋₆ alkylene group, in one aspect an ethylene group; and G is an oxygen atom or an —NR— group;

A fifth type of suitable fabric softening active has the formula:

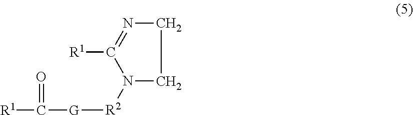

wherein R¹, R² and G are defined as above.

A sixth type of suitable fabric softening active are condensation reaction products of fatty acids with dialkylenetriamines in, e.g., a molecular ratio of about 2:1, said reaction products containing compounds of the formula:

R¹—C(O)—NH—R²—NH—R³—NH—C(O)—R¹ (6)

wherein R¹, R² are defined as above, and each R³ is a C₁₋₆ alkylene group, in one aspect an ethylene group and wherein the reaction products may optionally be quaternized by the additional of an alkylating agent such as dimethyl sulfate. Such quaternized reaction products are described in additional detail in U.S. Pat. No. 5,296,622, issued Mar. 22, 1994 to Uphues et al., which is incorporated herein by reference;

A seventh type of suitable fabric softening active has the formula:

[R¹—C(O)—NR—R²—N(R)₂—R³—NR—C(O)—R¹]⁺A⁻ (7)

wherein R, R¹, R², R³ and A⁻ are defined as above;

An eighth type of suitable fabric softening active are reaction products of fatty acid with hydroxyalkylalkylenediamines in a molecular ratio of about 2:1, said reaction products containing compounds of the formula:

R¹—C(O)—NH—R²—N(R³OH)—C(O)—R¹ (8)

wherein R¹, R² and R³ are defined as above;

A nineth type of suitable fabric softening active has the formula:

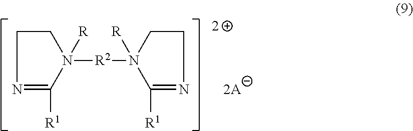

wherein R, R¹, R², and A⁻ are defined as above.

Non-limiting examples of compound (1) are N,N-bis(stearoyl-oxy-ethyl)N,N-dimethyl ammonium chloride, N,N-bis(tallowoyl-oxy-ethyl)N,N-dimethyl ammonium chloride, N,N-bis(stearoyl-oxy-ethyl)N-(2 hydroxyethyl) N-methyl ammonium methylsulfate.

Non-limiting examples of compound (2) is 1,2 di(stearoyl-oxy) 3 trimethyl ammoniumpropane chloride.

Non-limiting examples of Compound (3) are dialkylenedimethylammonium salts such as dicanoladimethylammonium chloride, di(hard)tallowedimethylammonium chloride dicanoladimethylammonium methylsulfate and 2-ethylhexylstearyldimenthylammonium chloride. An example of commercially available dialkylenedimethylammonium salts usable in the present invention is dioleyldimethylammonium chloride available from Evonic (Witco) Corporation under the trade name Adogen® 472 and dihardtallow dimethylammonium chloride available from Akzo Nobel Arquad 2HT75.

A non-limiting example of Compound (4) is 1-methyl-1-stearoylamidoethyl-2-stearoylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from the Evonick (Witco) Corporation under the trade name Varisoft®.

A non-limiting example of Compound (5) is 1-tallowylamidoethyl-2-tallowylimidazoline wherein R¹ is an acyclic aliphatic C₁₅-C₁₇ hydrocarbon group, R² is an ethylene group, and G is a NH group.

A non-limiting example of Compound (6) is the reaction products of fatty acids with diethylenetriamine in a molecular ratio of about 2:1, said reaction product mixture containing N,N″-dialkyldiethylenetriamine with the formula:

R¹—C(O)—NH—CH₂CH₂—NH—CH₂CH₂—NH—C(O)—R¹

wherein R¹—C(O) is an alkyl group of a commercially available fatty acid derived from a vegetable or animal source, such as Emersol® 223LL or Emersol® 7021, available from Henkel Corporation, and R² and R³ are divalent ethylene groups.

A non-limiting example of Compound (7) is a difatty amidoamine based softener having the formula:

[R¹—C(O)—NH—CH₂CH₂—N(CH₃)(CH₂CH₂OH)—CH₂CH₂—NH—C(O)—R¹]⁺CH₃SO₄⁻

wherein R¹—C(O) is an alkyl group, available commercially from the Evonik (Witco) Corporation e.g. under the trade name Varisoft® 222LT.

An example of Compound (8) is the reaction products of fatty acids with N-2-hydroxyethylethylenediamine in a molecular ratio of about 2:1, said reaction product mixture containing a compound of the formula:

R¹—C(O)—NH—CH₂CH₂—N(CH₂CH₂OH)—C(O)—R¹

wherein R¹—C(O) is an alkyl group of a commercially available fatty acid derived from a vegetable or animal source, such as Emersol® 223LL or Emersol® 7021, available from Henkel Corporation.

An example of Compound (9) is the diquaternary compound having the formula:

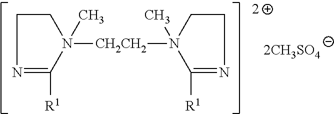

wherein R¹ is derived from fatty acid, and the compound is available from Witco Company.

It will be understood that combinations of softener actives disclosed above are suitable for use in this invention.

Anion A

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are suitable herein as anion A. The anion can also, but less preferably, carry a double charge in which case A⁻ represents half a group.

Anionic Polymers—In the present invention anionic polymers are anionic or amphoteric polymer with a net anionic charge, i.e. the total anionic charges on these polymers will exceed the total cationic charge. The anionic charge density of the polymer typically ranges from about 0.05 milliequivalents/g to about 23 milliequivalents/g. The charge density is calculated by dividing the number of net charge per repeating unit by the molecular weight of the repeating unit. The negative charges could be on the backbone of the polymers or the side chains of polymers. Non-limiting examples of anionic or amphoteric polymers include polysaccharides, proteins and synthetic polymers.

Polymers comprising groups derived from carboxylic, sulfonic or phosphoric acids and having a number molecular weight ranging from about 10,000 to 5,000,000 are non-limiting examples of anionic polymers that may be used.

Carboxylic moieties may be chosen from monoacidic and diacidic unsaturated carboxylic monomers, such as those of formula:

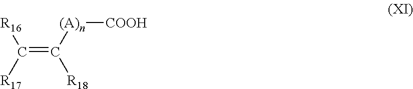

Wherein
N is an integer from 0 to 10,
A is a methylene moiety, optionally linked to the carbon atom of the unsaturated moiety or to the adjacent methylene moiety when n is more than 1, through a heteroatom such as oxygen and sulfur,
R16 is chosen from hydrogen, and the phenyl and benzyl moieties,
R17 is chosen from hydrogen, lower alkyl moieties, and carboxyl moieties,
R18 is chosen from hydrogen, lower alkyl moieties, and —CH2-COOH, phenyl, and benzyl moieties.

For example, in formula (XI), lower alkyl moieties may comprise from 1 to 4 carbon atoms and may be, for instance, methyl and ethyl moieties.

Non-limited examples of anionic polymers with carboxylic moieties that may be used include:
A) Acrylic and methacrylic homo- and copolymers, and salts thereof, for example products commercially marketed under the trade names VERSICOL® E or K by ALLIED COLLOID, ULTRAHOLD® by BASF, acrylic acid and acrylamide copolymers sold in their sodium salt from under the trade names RETEN® 421, 423 or 425 by HERCULES, and polyhydroxycarboxylic acids sodium salts.
B) Acrylic and methacrylic acid copolymers with a monoethylene monomer, such as ethylene, styrene, and vinyl esters, acrylic and methacrylic acid esters, optionally grafted onto a polyalkyleneglycol such as polyethyleneglycol, and optionally crosslinked. Copolymers of this type may comprise in their chain an acrylamide unit, optionally N-alkylated and/or hydroxyalkylated, such as those marketed under the trade name QUADRAMER® by AMERICAN CYANAMID. Acrylic acid and C1-C4 alkyl methacrylate copolymers, and methacrylic acid and ethyl acrylatecopolymers, commercially marketed under the trade name LUVIMER® MAEX by BASF, are further non-limiting examples.
C) Crotonic acid-derived copolymers, such as those comprising vinyl acetate or vinyl propionate units in their chain and operationally other monomers such as allyl and methallyl esters; vinylethers and vinylesters of a linear or branched, hydrocarbon long chain, saturated carboxylic acid, such as those comprising a least 5 carbon atoms, these polymers being optionally grafted and crosslinked; and vinyl, allyl, and methallyl esters of an α or β-cyclic carboxylic acid. Such polymers are sold by NATIONAL STARCH are non-limited examples of commercially available products belonging to this class.
D) Polymers derived from maleic, fumaric, or itaconic acids or anhydrides with vinyl esters, vinyl ethers, vinyl halogenides, phenylvinylic derivatives, acrylic acid, and esters thereof. These polymers may be esterified. Non-limiting examples include polymers commercially marketed under trade names GANTREZ® AN or ES by ISP.

Polymers also belonging to this class include copolymers of maleic, citaconic or itaconic anhydride and of an allylic or methallylic ester, optionally comprising an acrylamide or methacrylamide moiety, an α-olefin, acrylic or methacrylic esters, acrylic or methacrylic acids or vinylpyrrolidone in their chain, wherein the anhydride functionalities may be monoesterified or monoamidified.

E) Polyacrylamids Comprising Carboxylate Moieties.

As explained above, anionic polymers may also be polymers from sulfonic acid-derived groups.

Non-limiting examples of polymers comprising sulfone moieties include those comprising vinylsulfone, styrene-sulfone, naphthalene-sulfone, and acrylamide-alkyl-sulfone units.

The present composition may comprise an anionic polymer derived from saccharide based materials. Saccharide based materials may be natural or synthetic and include derivatives and modified saccharides. Suitable saccharide based materials include cellulose, gums, arabinans, galactans, seeds and mixtures thereof. Saccharide derivatives may include saccharides modified with, amino acids, carboxylic acids, sulphonates, sulphates, phosphates and mixtures thereof.

The present composition may comprise a cellulose derivative, such as carboxymethylcellulose and cellulose sulphate.

Cationic Polymers—In the present invention cationic polymers are cationic or amphoteric polymer with a net cationic charge, i.e. the total cationic charges on these polymers will exceed the total anionic charge. The cationic charge density of the polymer typically ranges from about 0.05 milliequivalents/g to about 23 milliequivalents/g. The charge density is calculated by dividing the number of net charge per repeating unit by the molecular weight of the repeating unit. The positive charges could be on the backbone of the polymers or the side chains of polymers. Nonlimiting examples of cationic or amphoteric polymers include polysaccharides, proteins and synthetic polymers.

a. Cationic Polysaccharides:

Cationic polysaccharides include but not limited to cationic cellulose derivatives, cationic guar gum derivatives, chitosan and derivatives and cationic starches. Cationic polysaccharides have a molecular weight from about 20,000 to about 2 million, in one aspect from about 100,000 to about 1,500,000.

One group of cationic polysaccharides is shown in Structural Formula I as follows:

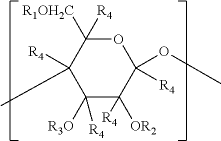

Alkyl substitution on the saccharide rings of the polymer range from about 0.01% to 5% per sugar unit, more preferably from about 0.05% to 2% per glucose unit, of the polymeric material.

For Structural Formula I R¹, R², R³ are each independently H, C₁₋₂₄ alkyl (linear or branched),

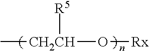

n is from about 0 to about 10; Rx is H, C₁₋₂₄ alkyl (linear or branched) or

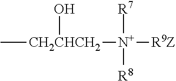

or mixtures thereof, wherein Z is a water soluble anion, in one aspect chloride, bromide iodide, hydroxide, phosphate sulfate, methyl sulfate and acetate; R⁵ is selected from H, or C₁-C₆ alkyl or mixtures thereof; R⁷, R⁸ and R⁹ are selected from H, or C₁-C₂₈ alkyl, benzyl or substituted benzyl or mixtures thereof.

R⁴ is H or —(P)ₘ—H, or mixtures thereof; wherein P is a repeat unit of an addition polymer formed by a cationic monomer.

Cationic polysaccharides include cationic hydroxyalkyl celluloses. Examples of cationic hydroxyalkyl cellulose include those with the INCI name Polyquaternium10 such as those sold under the trade names Ucare Polymer JR 30M, JR 400, JR 125, LR 400 and LK 400 polymers; Polyquaternium 67 sold under the trade name Softcat SK™, all of which are marketed by Amerchol Corporation Edgewater N.J.; and Polyquaternium 4 sold under the trade name Celquat H200 and Celquat L-200 available from National Starch and Chemical Company, Bridgewater, N.J. Other suitable polysaccharides include Hydroxyethyl cellulose or hydroxypropylcellulose quaternized with glycidyl C₁₂-C₂₂ alkyl dimethyl ammonium chloride. Examples of such polysaccahrides include the polymers with the INCI names Polyquaternium 24 sold under the trade name Quaternium LM 200, PG-Hydroxyethylcellulose Lauryldimonium Chloride sold under the trade name Crodacel LM, PG-Hydroxyethylcellulose Cocodimonium Chloride sold under the trade name Crodacel QM and, PG-Hydroxyethylcellulose stearyldimonium Chloride sold under the trade name Crodacel QS and alkyldimethylammonium hydroxypropyl oxyethyl cellulose.

In one embodiment of the present invention, the cationic polymer comprises cationic starch. These are described in U.S. Pat. No. 7,135,451, col. 2, line 33—col. 4, line 67. In another embodiment, the cationic starch of the present invention comprises amylose at a level of from about 0% to about 70% by weight of the cationic starch. In yet another embodiment, when the cationic starch comprises cationic maize starch, said cationic starch comprises from about 25% to about 30% amylose, by weight of the cationic starch. The remaining polymer in the above embodiments comprises amylopectin.

A third group of suitable polysaccahrides are cationic galactomanans, such as cationic guar gums or cationic locust bean gum. Example of cationic guar gum is a quaternary ammonium derivative of Hydroxypropyl Guar sold under the trade name Jaguar C13 and Jaguar Excel available from Rhodia, Inc of Cranburry N.J. and N-Hance by Aqualon, Wilmington, Del.

b. Synthetic Cationic Polymers

Cationic polymers in general and their method of manufacture are known in the literature. The Molecular weight of these polymers is in the range of about 2,000 to about 5 million.

In one embodiment, the cationic monomer is selected from methacrylamidotrimethylammonium chloride, dimethyl diallyl ammonium having the formula:

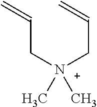

which results in a polymer or co-polymer having units with the formula:

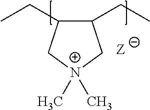

wherein Z′ is a water-soluble anion, preferably chloride, bromide iodide, hydroxide, phosphate sulfate, methyl sulfate and acetate or mixtures thereof and repeat units is from about 10 to about 50,000.
   i. Addition Polymers

Synthetic polymers include but are not limited to synthetic addition polymers of the general structure

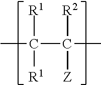

wherein R¹, R², and Z are defined herein below. In one aspect, the linear polymer units are formed from linearly polymerizing monomers. Linearly polymerizing monomers are defined herein as monomers which under standard polymerizing conditions result in a linear or branched polymer chain or alternatively which linearly propagate polymerization. The linearly polymerizing monomers of the present invention have the formula:

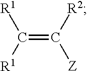

however, those of skill in the art recognize that many useful linear monomer units are introduced indirectly, inter alia, vinyl amine units, vinyl alcohol units, and not by way of linearly polymerizing monomers. For example, vinyl acetate monomers once incorporated into the backbone are hydrolyzed to form vinyl alcohol units. For the purposes of the present invention, linear polymer units may be directly introduced, i.e. via linearly polymerizing units, or indirectly, i.e. via a precursor as in the case of vinyl alcohol cited herein above.

Each R¹ is independently hydrogen, C₁-C₁₂ alkyl, substituted or unsubstituted phenyl, substituted or unsubstituted benzyl, —ORₐ, or —C(O)ORₐ wherein Rₐ is selected from hydrogen, and C₁-C₂₄ alkyl and mixtures thereof. In one aspect R′ is hydrogen, C₁-C₄ alkyl, or —ORₐ, or —C(O)ORₐ

Each R² is independently hydrogen, hydroxyl, halogen, C₁-C₁₂ alkyl, —ORₐ, substituted or unsubstituted phenyl, substituted or unsubstituted benzyl, carbocyclic, heterocyclic, and mixtures thereof. In one aspect, R² is hydrogen, C₁-C₄ alkyl, and mixtures thereof.

Each Z is independently hydrogen, halogen; linear or branched C₁-C₃₀ alkyl, nitrilo, N(R₃)₂—C(O)N(R₃)₂; —NHCHO (formamide);
—OR³, —O(CH₂)ₙN(R³)₂, —O(CH₂)ₙN⁺(R³)₃X^{-.} —C(O)OR⁴; —C(O)N—(R³)₂
—C(O)O(CH₂)ₙN(R³)₂, —C(O)O(CH₂)ₙN⁺(R³)₃X⁻, —OCO(CH₂)ₙN(R³)₂, —OCO(CH₂)ₙN⁺(R³)₃X⁻,
—C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻,
each R₃ is independently hydrogen, C₁-C₂₄ alkyl, C₂-C₈ hydroxyalkyl, benzyl; substituted benzyl and mixtures thereof;
each R₄ is independently hydrogen or C₁-C₂₄ alkyl, and

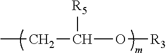

X is a water soluble anion; the index n is from 1 to 6.
R₅ is independently hydrogen, C₁-C₆ alkyl,
and mixtures thereof
Z can also be selected from non-aromatic nitrogen heterocycle comprising a quaternary ammonium ion, heterocycle comprising an N-oxide moiety, an aromatic nitrogen containing heterocyclic wherein one or more or the nitrogen atoms is quaternized; an aromatic nitrogen containing heterocycle wherein at least one nitrogen is an N-oxide; or mixtures thereof. Non-limiting examples of addition polymerizing monomers comprising a heterocyclic Z unit includes 1-vinyl-2-pyrrolidinone, 1-vinylimidazole, quaternized vinyl imidazole, 2-vinyl-1,3-dioxolane, 4-vinyl-1-cyclohexene1,2-epoxide, and 2-vinylpyridine, 2-vinylpyridine N-oxide, 4-vinylpyridine 4-vinylpyridine N-oxide.

A non-limiting example of a Z unit which can be made to form a cationic charge in situ is the —NHCHO unit, formamide. The formulator can prepare a polymer or co-polymer comprising formamide units some of which are subsequently hydrolyzed to form vinyl amine equivalents.

The polymers and co-polymers of the present invention comprise Z units which have a cationic charge or which result in a unit which forms a cationic charge in situ. When the co-polymers of the present invention comprise more than one Z unit, for example, Z¹, Z², . . . , Zⁿ units, at least about 1% of the monomers which comprise the co-polymers will comprise a cationic unit.

The polymers or co-polymers of the present invention can comprise one or more cyclic polymer units which are derived from cyclically polymerizing monomers. Cyclically polymerizing monomers are defined herein as monomers which under standard polymerizing conditions result in a cyclic polymer residue as well as serving to linearly propagate polymerization. Suitable cyclically polymerizing monomers of the present invention have the formula:

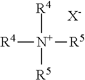

wherein each R⁴ is independently an olefin comprising unit which is capable of propagating polymerization in addition to forming a cyclic residue with an adjacent R⁴ unit; R⁵ is C₁-C₁₂ linear or branched alkyl, benzyl, substituted benzyl, and mixtures thereof; X is a water soluble anion.

Non-limiting examples of R⁴ units include allyl and alkyl substituted allyl units. In one aspect the resulting cyclic residue is a six-member ring comprising a quaternary nitrogen atom.

R⁵ is in one aspect C₁-C₄ alkyl, in one aspect methyl.

An example of a cyclically polymerizing monomer is dimethyl diallyl ammonium having the formula:

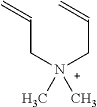

which results in a polymer or co-polymer having units with the formula:

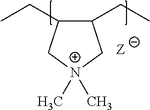

wherein in one aspect the index of repeat units is from about 10 to about 50,000.

The polymers may be crosslinked. Examples of crosslinking monomers include but not limited to divinylbenzene, ethyleneglycoldiacrylate.

Nonlimiting examples of Suitable polymers according to the present invention include copolymers made from one or more cationic monomers selected from the group consisting N,N-dialkylaminoalkyl methacrylate, N,N-dialkylaminoalkyl acrylate, N,N-dialkylaminoalkyl acrylamide, N,N-dialkylaminoalkylmethacrylamide, quaternized N,N-dialkylaminoalkyl methacrylate, quaternized N,N-dialkylaminoalkyl acrylate, quaternized N,N-dialkylaminoalkyl acrylamide, quaternized N,N-dialkylaminoalkylmethacrylamide, vinylamine and its derivatives, allylamine and its derivatives, vinyl imidazole, quaternized vinyl imidazole and diallyl dialkyl ammonium chloride.

And optionally a second monomer selected from a group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glycol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole and derivatives, acrylic acid, methacrylic acid, maleic acid, vinyl sulfonic acid, styrene sulfonic acid, acrylamidopropylmethane sulfonic acid (AMPS) and their salts

The polymer may optionally be cross-linked. Crosslinking monomers include, but are not limited to, ethylene glycoldiacrylatate, divinylbenzene, butadiene.

Suitable cationic monomers include N,N-dimethyl aminoethyl acrylate, N,N-dimethyl aminoethyl methacrylate (DMAM), [2-(methacryloylamino)ethyl]tri-methylammonium chloride (QDMAM), N,N-dimethylaminopropyl acrylamide (DMAPA), N,N-dimethylaminopropyl methacrylamide (DMAPMA), acrylamidopropyl trimethyl ammonium chloride, methacrylamidopropyl trimethylammonium chloride, quaternized vinyl imidazole and diallyldimethylammonium chloride and derivatives thereof.

Suitable second monomers include acrylamide, N,N-dimethyl acrylamide, C1-C4 alkyl acrylate, C1-C4 hydroxyalkylacrylate, vinyl formamide, vinyl acetate, and vinyl alcohol. In one aspect, suitable nonionic monomers are acrylamide, hydroxyethyl acrylate (HEA), hydroxypropyl acrylate and derivative thereof,

In another aspect suitable synthetic polymers include poly(acrylamide-co-diallyldimethylammonium chloride), poly(acrylamide-methacrylamidopropyltrimethyl ammonium chloride), poly(acrylamide-co-N,N-dimethyl aminoethyl methacrylate), poly(acrylamide-co-N,N-dimethyl aminoethyl methacrylate), poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid),

ii. Polyethyleneimine and its derivatives.

These are commercially available under the trade name Lupasol ex. BASF AG of Ludwigshafen, Germany. In one embodiment, the polyethylene derivative is an amide derivative of polyetheyleneimine sold under the trade name Lupasol SK. Also included are alkoxylated polyethleneimine; alkyl polyethyleneimine and quaternized polyethyleneimine.

iii. Polyamidoamine-epichlorohydrin (PAE) Resins condensation products of polyalkylenepolyamine with polycarboxylc acid. The most common PAE resins are the condensation products of diethylenetriamine with adipic acid followed by a subsequent reaction with epichlorohydrin. They are available from Hercules Inc. of Wilmington Del. under the trade name Kymene or from BASF A.G. under the trade name Luresin.

Polymers that exhibit stable compositions of the present invention include but not limited to Rheovis CDE (BASF) and Flosoft 222 (SNF Floerger).

### Nonionic Polymers

The composition of the present invention may contain a nonionic polymer. Non-limiting examples of non-ionic polymers for use in the personal care composition include methyl hydroxypropyl cellulose, xanthan gum, alhinate polysaccharide Gellan Gum (Kelcogel from CP Kelco), polysaccharide gum, hydroxylpropyl cellulose (Methocel from Down/Amerchol), hydroxyl propyl methyl cellulose (Klucel from Hercules), hydroxylethyl cellulose, polyalkylene glycols, and mixtures thereof. Particularly useful non-ionic polymers include polysaccharide gum, hydroxyl propyl cellulose, hydroxyl propyl methyl cellulose, or combinations thereof.

### Adjunct Materials for Consumer Products

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. It is understood that such adjuncts are in addition to the dye conjugate and optional stripping agent components of Applicants' compositions. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, structurants, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential to Applicants' compositions. Thus, certain embodiments of Applicants' compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. However, when one or more adjuncts are present, such one or more adjuncts may be present as detailed below:

Bleaching Agents

Bleaching agents other than bleaching catalysts include photobleaches, bleach activators, hydrogen peroxide, sources of hydrogen peroxide, preformed peracids. Examples of suitable bleaching agents include anhydrous sodium perborate (mono or tetrahydrate), anhydrous sodium percarbonate, tetraacetyl ethylene diamine, nonanoyloxybenzene sulfonate, sulfonated zinc phtalocyanine and mixtures thereof.

When a bleaching agent is used, the compositions of the present invention may comprise from about 0.1% to about 50% or even from about 0.1% to about 25% bleaching agent by weight of the subject cleaning composition.

Surfactants

The compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof.

The surfactant is typically present at a level of from about 0.1% to about 60%, from about 1% to about 50% or even from about 5% to about 40% by weight of the subject composition.

Builders

The compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds. ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents

The compositions herein may contain a chelating agent. Suitable chelating agents include copper, iron and/or manganese chelating agents and mixtures thereof.

When a chelating agent is used, the composition may comprise from about 0.1% to about 15% or even from about 3.0% to about 10% chelating agent by weight of the subject composition.

Dye Transfer Inhibiting Agents

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in a subject composition, the dye transfer inhibiting agents may be present at levels from about 0.0001% to about 10%, from about 0.01% to about 5% or even from about 0.1% to about 3% by weight of the composition.

Dispersants

The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes

The compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratanases, reductases, oxidases, phenoloxidases, lipoxygenases, ligninases, pullulanases, tannases, pentosanases, malanases, B-glucanases, arabinosidases, hyaluronidase, chondroitinase, laccase, and amylases, or mixtures thereof. A typical combination is an enzyme cocktail that comprises a protease, lipase, cutinase and/or cellulase in conjunction with amylase.

When present in a cleaning composition, the aforementioned adjunct enzymes may be present at levels from about 0.00001% to about 2%, from about 0.0001% to about 1% or even from about 0.001% to about 0.5% enzyme protein by weight of the composition.

Enzyme Stabilizers

Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor can be added to further improve stability.

Catalytic Metal Complexes

Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminium cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of a macropolycyclic rigid ligand—abbreviated as “MRL”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRL's include 5,12-diethyl-1,5,8,12-tetraazabicyclo[6.6.2]hexadecane.

Suitable transition metal MRLs are readily prepared by known procedures, such as taught for example in U.S. Pat. No. 6,225,464.

### Processes of Making Consumer Products

The cleaning compositions of the present invention can be formulated into any suitable form and prepared by any process chosen by the formulator, non-limiting examples of which are described in Applicants examples and in U.S. Pat. No. 5,879,584; U.S. Pat. No. 5,691,297; U.S. Pat. No. 5,574,005; U.S. all of which are incorporated herein by reference.

### Method of Use

The consumer products of the present invention may be used in any conventional manner. In short, they may be used in the same manner as consumer products that are designed and produced by conventional methods and processes. For example, cleaning and/or treatment compositions of the present invention can be used to clean and/or treat a situs inter alia a surface or fabric. Typically at least a portion of the situs is contacted with an embodiment of Applicants' composition, in neat form or diluted in a wash liquor, and then the situs is optionally washed and/or rinsed. For purposes of the present invention, washing includes but is not limited to, scrubbing, and mechanical agitation. The fabric may comprise any fabric capable of being laundered in normal consumer use conditions. Cleaning solutions that comprise the disclosed cleaning compositions typically have a pH of from about 5 to about 10.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric mass ratio is typically from about 1:1 to about 100:1.

The consumer products of the present invention may be used as liquid fabric enhancers wherein they are applied to a fabric and the fabric is then dried via line drying and/or drying the an automatic dryer.

### Quality Control Method

In one aspect, a quality control process comprising using an equation comprising the variables Y, X, b, and a, said variables being arranged in the order of the equation below, to determine if a polymer is acceptable for use in a two phase system:

Y=bX^{a}

wherein:
X is the polymer concentration in the solvent polymer solution
Y is the polymer solvent solution viscosity at a shear rate of 0.01 l/s,
b is the extrapolated solvent polymer solution viscosity when X is extrapolated to unity and the exponent a is, over the range of the fit, greater than or equal to 4,
accepting said polymer when the exponent a is greater than or equal to 4 over at least 0.1%, at least 0.2%, from 0.2% to about 1%, or even from 0.2% to about 0.5% of the range of X equals 0.001 weight % to 25 weight % polymer, is disclosed.

### EXAMPLES

The solvent phase was prepared gravimetrically by adding about 0.1 ppm hydrochloric acid to deionized water. A series of polymer solvent solutions were prepared to logarithmically span between 0.01 and 1 polymer weight percent of the polymer solvent solution. Each polymer solvent solutions was prepared gravimetrically by mixing the polymer and solvent with a SpeedMixer DAC 150 FVZ-K (made by FlackTek Inc. of Landrum, S.C.) for 1 minute at 2,500 RPM in a Max 60 cup or Max 100 cup to the target polymer weight percent of the polymer solvent solution. Viscosity as a function of shear rate of each polymer solvent solutions was measured at 40 different shear rates using an Anton Paar rheometer with a DSR 301 measuring head and concentric cylinder geometry. The time differential for each measurement was logarithmic over the range of 180 and 10 seconds and the shear rate range for the measurements was 0.001 to 500 l/s (measurements taken from the low shear rate to the high shear rate).

TABLE 1

| Polymer I | | Polymer II | | Polymer III | |
|---|---|---|---|---|---|
| (Rheovis CDE) | | (Flosoft 222) | | (Jaypo 213) | |
| Polymer | Viscosity^{#} | Polymer | Viscosity^{#} | Polymer | Viscosity^{#} |
| [wt. %] | [Pa s] | [wt. %] | [Pa s] | [wt. %] | [Pa s] |
| 0.14% | 0.04 | 0.18% | 0.1 | 0.25% | 0.32 |
| 0.18% | 0.18 | 0.22% | 0.47 | 0.32% | 0.81 |
| 0.22% | 0.52 | 0.28% | 4.15 | 0.40% | 5.26 |
| 0.27% | 1.95 | 0.34% | 17.5 | 0.50% | 66.3 |
| 0.34% | 5.17 | 0.43% | 61.7 | 0.63% | 368 |

^{#}Viscosity at a shear rate of 0.01 1/s

Viscosity at a shear rate of 0.01 l/s as a function of polymer weight percent of the polymer solvent solution were fit using the equation Y=bX^{a} wherein X was the polymer concentration in the solvent polymer solution, Y was the polymer solvent solution viscosity, b was the extrapolated solvent polymer solution viscosity when X was extrapolated to unity and the exponent a was polymer concentration viscosity scaling power over the polymer concentration range where the exponent a was the highest value.

TABLE 2

| Polymer* | a | b |
|---|---|---|
| Polymer I (Rheovis CDE) | 5.55 | 3.00E+14 |
| Polymer II (Flosoft 222) | 7.56 | 6.46E+19 |
| Polymer III (Jaypol 213) | 8.11 | 2.29E+20 |

*Polymer I supplied by BASF Corp. of Ludwigshafen, Germany, Polymer II supplied by SNF Floerger 42163 Andrezieux Cedex, France, and Polymer III supplied by Ashland Inc. Covington, KY USA.

The composition of two phase solutions are listed in Table 3. They are prepared by
1. Heating the solvent phase to about 70° C.
2. Adding the antifoam, preservative and DTPA to the solvent phase to form a first mixture
3. Comelting a fabric softener active with a low molecular weight alcohol to about 70° C.
4. Adding the softener active to the first mixture using high shear mixing to disperse the molten softener active to form the second mixture
5. Adding calcium chloride solution and cooling the two phase solution to 25° C. using chilled water circulated through a cooling coil
6. Adding perfume, encapsulated perfume, PDMS emulsion, and dye using an overhead mixer

TABLE 3

| (% wt) | S1 | S2 | S3 | S4 |
|---|---|---|---|---|
| Fabric Softener Active ^{a} | 15.8 | 10.0 | 17.0 | 7.0 |
| Low MW alcohol | 1.9 | 1.5 | 3.0 | 0.9 |
| Perfume | 1.7 | 1.2 | 1.7 | 0.8 |
| Perfume Encapsulation | 0.6 | 0.3 | 0.4 | — |
| Calcium Chloride | 0.15 | 0.10 | 0.2 | 0.10 |
| DTPA ^{b} | 0.005 | 0.005 | 0.005 | 0.005 |
| Preservative (parts per million) ^{c} | 5 | 5 | 5 | 5 |
| Antifoam ^{d} | 0.15 | 0.11 | 0.15 | 0.15 |
| PDMS Emulsion ^{e} | — | 0.5 | 2 | 2.0 |
| Dye (parts per million) | 40 | 11 | 30 | 50 |
| Hydrochloric Acid | 0.01 | 0.01 | 0.10 | 0.01 |
| Deionized Water | Balance | Balance | Balance | Balance |

^{a} N,N-di(tallowoyloxyethyl)-N,N-dimethylammonium chloride.
^{b} Diethylene triamine pentaacetic acid.
^{c} Koralone ™ B-119 available from Dow.
^{d} Silicone antifoam agent available from Dow Corning ® under the trade name DC2310.
^{e} Polydimethylsiloxane emulsion from Dow Corning ® under the trade name DC346.

Polymers with an a value greater than four are added to the two phase solution with overhead mixing at room temperature to form a stable two phase polymer mixture. Two phase solutions containing a polymer with an a exponent value less than 4 are unstable and phase separate which is unacceptable for a consumer product. Two phase solutions containing a polymer with an a value greater than 4 are stable and persist as a single phase.

TABLE 4

| Two Phase | Polymer | Polymer | Two Phase Polymer |
|---|---|---|---|
| System | Type | [wt. %] | Mixture Stability |
| S1 | I | 0.08% | Stable at 8 weeks |
| S1 | II | 0.08% | Stable at 8 weeks |
| S2 | I | 0.06% | Stable at 12 weeks |
| S3 | I | 0.08% | Stable at 24 weeks |
| S3 | II | 0.08% | Stable at 24 weeks |
| S4 | III | 0.15% | Stable at 12 weeks |

The two phase solutions containing polymers I and/or II are used as fabric enhancing product. Consumers dose approximately 25 g into a cloths washing machine during the rinse cycle. It can be added directly to the rinse water or poured into an automatic fabric softener dispenser. Clothing is either line or machine dried. Using these two phase polymer containing solutions provides acceptable softness to clothing.

### Example #2 Quality Control

The solvent phase is deionized water. Three batches of the same polymer are considered. A series of polymer solvent solutions are prepared for each polymer lot to logarithmically span between 0.01 and 1 polymer weight percent of the polymer solvent solution. Each polymer solvent solutions is prepared gravimetrically by mixing the polymer and solvent with a SpeedMixer DAC 150 FVZ-K (made by FlackTek Inc. of Landrum, S.C.) for 1 minute at 2,500 RPM in a Max 60 cup or Max 100 cup to the target polymer weight percent of the polymer solvent solution. Viscosity as a function of shear rate of each polymer solvent solutions is measured at 40 different shear rates using an Anton Paar rheometer with a DSR 301 measuring head and concentric cylinder geometry. The time differential for each measurement is logarithmic over the range of 180 and 10 seconds and the shear rate range for the measurements is 0.001 to 500 l/s (measurements taken from the low shear rate to the high shear rate).

Viscosity at a shear rate of 0.01 l/s as a function of polymer weight percent of the polymer solvent solution are fit using the equation Y=bX^{a} wherein X is the polymer concentration in the solvent polymer solution, Y is the polymer solvent solution viscosity, b is the extrapolated solvent polymer solution viscosity when X is extrapolated to unity and the exponent “a” is polymer concentration viscosity scaling power over the polymer concentration range where the exponent “a” is the highest value. Polymer lots L1 and L2 have an exponent “a” greater than 4 and L3 has an a exponent smaller than 4.

The composition of two phase solutions is listed as S4 Table 3. It is prepared by
1. Heating the solvent phase to about 70° C.
2. Adding the antifoam, preservative and DTPA to the solvent phase to form a first mixture
3. Comelting a fabric softener active with a low molecular weight alcohol to about 70° C.
4. Adding the softener active to the first mixture using high shear mixing to disperse the molten softener active to form the second mixture
5. Adding calcium chloride solution and cooling the two phase solution to 25° C. using chilled water circulated through a cooling coil
6. Adding perfume, encapsulated perfume, PDMS emulsion, and dye using an overhead mixer

Polymer lots L1 and L2 are added to the two phase solution with overhead mixing at room temperature to form a stable two phase polymer mixture. Two phase solutions containing a polymer lot L3 is unstable and phase separate and this is unacceptable for a consumer product. Two phase solutions containing a polymer lots with an exponent “a” value greater than 4 are stable and persist as a single phase. This ensures the quality of the polymer to be stable in two phase mixtures before the polymer containing two phase mixture is made.

The two phase solutions containing polymer lots L1 and/or L2 are used as fabric enhancing products. Consumers dose approximately 35 g into a cloths washing machine during the rinse cycle. It can be added directly to the rinse water or poured into an automatic fabric softener dispenser. Clothing is either line or machine dried. Using these two phase polymer containing solutions provides acceptable softness to clothing.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of making a consumer product, said process comprising:
a) adding a polymer to a two phase system, said two phase system comprising a solvent phase and an active dispersed in said solvent phase as discrete particles; or
b) adding a polymer to a solvent and combining said solvent polymer combination and forming a two phase system by dispersing an active to form discrete active particles in said solvent polymer combination,
wherein said polymer has a substantially equal or neutral charge in relation to said discrete particles and for the equation below,
Y=bX^{a}
wherein:
X is the polymer concentration in the solvent polymer solution
Y is the polymer solvent solution viscosity at a shear rate of 0.01 l/s,
b is the extrapolated solvent polymer solution viscosity when X is extrapolated to unity and the exponent a is, over the range of the fit, greater than or equal to 4,
the polymer is selected such that the exponent a is greater than or equal to 4, from about 4 to about 50, from about 4.5 to about 50, from about 4.5 to about 20, from about 5 to about 20, from about 5 to about 10, from about 5 to about 7;
over at least 0.1%, at least 0.2%, from 0.2% to about 1%, or even from 0.2% to about 0.5% of the range of X equals 0.001 weight % to 25 weight % polymer.

2. A process according to claim 1 wherein the polymer is selected such that the exponent a is from about 5 to about 20 over from 0.2% to about 1%, of the range of X equals 0.001 weight % to 25 weight % polymer.

3. A process according to claim 1 wherein the polymer is selected such that the exponent a is greater than or equal to 4, from about 4 to about 50, from about 4.5 to about 50, from about 4.5 to about 20, from about 5 to about 20, from about 5 to about 10, from about 5 to about 7; over at least 0.1%, at least 0.2%, from 0.2% to about 1%, or even from 0.2% to about 0.5% of the range of X equals 0.001 weight % to 25 weight % polymer.

4. A process of making a consumer product, said process comprising:
using an equation comprising the variables Y, X, b, and a, said variables being arranged in the order of the equation below, to select a polymer:
Y=bX^{a}
wherein:
X is the polymer concentration in the solvent polymer solution
Y is the polymer solvent solution viscosity at a shear rate of 0.01 l/s,
b is the extrapolated solvent polymer solution viscosity when X is extrapolated to unity and the exponent a is, over the range of the fit, greater than or equal to 4,
said polymer being selected such that the exponent a is greater than or equal to 4, from about 4 to about 50, from about 4.5 to about 50, from about 4.5 to about 20, from about 5 to about 20, from about 5 to about 10, from about 5 to about 7;
over at least 0.1%, at least 0.2%, from 0.2% to about 1%, or even from 0.2% to about 0.5% of the range of X equals 0.001 weight % to 25 weight % polymer; and
a) adding said polymer to a two phase system, said two phase system comprising a solvent phase and an active dispersed in said solvent phase as discrete particles; or
b) adding a polymer to a solvent and combining said solvent polymer combination and forming a two phase system by dispersing an active to form discrete active particles in said solvent polymer combination,
said polymer having a substantially equal or neutral charge in relation to said discrete particles.

5. A process of making a consumer product, said process comprising:
a) adding a polymer to a two phase system, said two phase system comprising a solvent phase and an active dispersed in said solvent phase as discrete particles; or
b) adding a polymer to a solvent and combining said solvent polymer combination and forming a two phase system by dispersing an active to form discrete active particles in said solvent polymer combination,
wherein said polymer has a substantially equal or neutral charge in relation to said discrete particles and for the equation below:
Y=bX^{a}
wherein:
X is the polymer concentration in said two phase system,
Y is the viscosity of said two phase system at a shear rate of 0.01 l/s,
b is the extrapolated two phase system viscosity when X is extrapolated to unity and the exponent a is, over the range of the fit, greater than or equal to 4,
the polymer is selected such that the exponent a is greater than or equal to 4, from about 4 to about 50, from about 4.5 to about 50, from about 4.5 to about 20, from about 5 to about 20, from about 5 to about 10, from about 5 to about 7;
over at least 0.1%, at least 0.2%, from 0.2% to about 1%, or even from 0.2% to about 0.5% of the range of X equals 0.001 weight % to 25 weight % polymer.

6. A process of making a consumer product, said process comprising:
a) adding said selected polymer to a two phase system, said two phase system comprising a solvent phase and an active dispersed in said solvent phase as discrete particles; or
b) adding said selected polymer to a solvent and combining said solvent polymer combination and forming a two phase system by dispersing an active to form discrete active particles in said solvent polymer combination,
said polymer having a substantially equal or neutral charge in relation to said discrete particles wherein said polymer is selected by using an equation comprising the variables Y, X, b, and a, said variables being arranged in the order of the equation below:
Y=bX^{a}
wherein:
X is the polymer concentration in said two phase system,
Y is the two phase system viscosity at a shear rate of 0.01 l/s,
b is the extrapolated two phase system viscosity when X is extrapolated to unity and the exponent a is, over the range of the fit, greater than or equal to 4,
said polymer being selected such that the exponent a is greater than or equal to 4, from about 4 to about 50, from about 4.5 to about 50, from about 4.5 to about 20, from about 5 to about 20, from about 5 to about 10, from about 5 to about 7; over at least 0.1%, at least 0.2%, from 0.2% to about 1%, or even from 0.2% to about 0.5% of the range of X equals 0.001 weight % to 25 weight % polymer.

7. A quality control process comprising using an equation comprising the variables Y, X, b, and a, said variables being arranged in the order of the equation below, to determine if a polymer is acceptable for use in a two phase system:
Y=bX^{a}
wherein:
X is the polymer concentration in the solvent polymer solution
Y is the polymer solvent solution viscosity at a shear rate of 0.01 l/s,
b is the extrapolated solvent polymer solution viscosity when X is extrapolated to unity and the exponent a is, over the range of the fit, greater than or equal to 4,
accepting said polymer when the exponent a is greater than or equal to 4 over at least 0.1%, at least 0.2%, from 0.2% to about 1%, or even from 0.2% to about 0.5% of the range of X equals 0.001 weight % to 25 weight % polymer.

8. A consumer product made according to any of the processes of claims 1-6.

9. The consumer product of claim 8, said consumer product comprising a fabric softening active.
